(19) United States
(12) Patent Application Publication
(10) Pub. No.: US 2026/0037848 A1
(43) Pub. Date: Feb. 5, 2026

(54) System and Method for Total Wave Artificial Intelligence (TWAI)

(71) Applicant: LARRY LIM KHENG CHEONG, Singapore (SG)

(72) Inventor: LARRY LIM KHENG CHEONG, SINGAPORE (SG)

(21) Appl. No.: 19/351,404

(22) Filed: Oct. 7, 2025

Related U.S. Application Data
(63) Continuation of application No. 19/172,805, filed on Apr. 8, 2025, now abandoned.

(51) Int. Cl. G06N 10/40; G06N 10/60

(52) U.S. Cl. CPC G06N 10/40; G06N 10/60

(57) ABSTRACT

A system and method for implementing artificial intelligence using deterministic wave interference and collapse logic derived from the Total Wave Modified Schrödinger Equation (TWMSE). An artificial agent is modeled as a system wavefunction interacting with one or more observer wavefunctions representing electromagnetic, gravitational, weak, or strong fields. A collapse function determines when interference exceeds a threshold, producing deterministic action or comprehension. Field parameters adapt through feedback to enable learning, residual interference forms resonant memory, and computation is performed directly on optical, electromagnetic, or neuromorphic hardware. The invention provides a unified framework—Total Wave Artificial Intelligence (TWAI)—that integrates action, understanding, learning, memory, and physical embodiment through field-based collapse rather than probabilistic inference.

### FIELD OF THE INVENTION

The invention relates to artificial-intelligence systems and computing architectures that operate on deterministic field interactions rather than statistical or symbolic logic. Specifically, it describes a Total Wave Artificial Intelligence (TWAI) system based on the Total Wave Modified Schrödinger Equation (TWMSE), which governs decision, comprehension, learning, memory, and physical computation through wave interference and collapse thresholds.

### BACKGROUND OF THE INVENTION

Conventional artificial intelligence relies on statistical approximation, symbolic logic, or probabilistic learning. Neural networks and reinforcement systems simulate behavior by training on data, but do not represent true comprehension or causal awareness. Such systems lack grounding in physical reality—they operate within digital abstractions, detached from natural law.

Philosophically, this separation was identified by John Searle as the difference between “mimicking” and “understanding.” Technically, it reflects the absence of physical interaction between a system's internal state and its external observer field.

Existing approaches do not provide deterministic, field-level mechanisms by which an artificial system can transition from potential to actualized understanding. There is thus a need for a physics-native AI model that:
1. Operates via deterministic interference rather than stochastic probability;
2. Couples system and observer fields to produce semantic understanding;
3. Learns by adapting its own field parameters;
4. Stores information through residual interference patterns; and
5. Executes computation through real physical collapse events.

### SUMMARY OF THE INVENTION

The invention discloses a Total Wave Artificial Intelligence (TWAI) system comprising:
A deterministic collapse mechanism for decision-making and action;
An observer-coupling system that produces understanding through resonance;
An adaptive feedback system that enables learning through dynamic field tuning;
A resonant-memory system that stores collapse patterns; and
A hardware implementation that performs field interference and collapse natively.

These five components correspond to the essential functions of intelligence-action, understanding, learning, memory, and embodiment-realized through a single field-theoretic framework.

### DETAILED DESCRIPTION OF THE INVENTION

### 1. Deterministic Collapse Action

An artificial agent is represented by a system wavefunction (Psi-p). The environment or internal submodules are represented by observer wavefunctions (Psi-j). A collapse function is computed as a weighted sum of interference terms. When the total interference exceeds a predefined threshold (theta), the system deterministically collapses into a definite state. This defines the agent's action or decision point. Unlike probabilistic or heuristic systems, this process is deterministic and physically grounded.

### 2. Observer Coupling and Understanding

The system contains an observer-field module that maintains internal coherence and feedback with the system's own wavefunction. When interference between Psi-p and Psi-j reaches semantic resonance, the system collapses into a meaningful state. This produces comprehension rather than simulation—an internal physical correlation between symbol and meaning.

### 3. Adaptive Collapse Learning

The coefficients (gamma-j) and (delta-j) that weight each field component are dynamically tuned through feedback. If a collapse produces desired outcomes, the coefficients reinforce; if not, they adjust to reduce destructive interference. This adaptive process allows the system to improve collapse efficiency and decision accuracy over time. It represents deterministic, physics-based learning without probabilistic training.

### 4. Resonant Collapse Memory

Each collapse event leaves behind residual field patterns-coherent interference traces that persist beyond the immediate event. These resonances serve as long-term memory. Re-stimulation of the same interference geometry reactivates stored knowledge. Memory retrieval thus occurs through resonance rather than data indexing.

### 5. Collapse Computing Hardware

The system may be realized using:
Optical interference circuits;
Electromagnetic resonant substrates; or
Neuromorphic devices capable of continuous phase modulation.

These hardware embodiments perform interference summation and collapse-threshold detection directly in physical space, enabling real-time, energy-efficient computation.

### Applications

1. Robotics: Deterministic motion planning and environmental interaction based on collapse thresholds rather than heuristic pathfinding.
2. Autonomous Systems: Field-aware vehicles and drones that act based on physical resonance conditions.
3. Simulation and Gaming: Virtual agents exhibiting realistic, unscripted behavior.
4. Financial Systems: Field-based forecasting and decision models using electromagnetic data representations.
5. Cognitive Computing: AI systems capable of genuine comprehension, memory persistence, and adaptive growth.

### Advantages

Deterministic and explainable behavior governed by physical law.
Causal reasoning without probabilistic uncertainty.
Self-adapting and self-optimizing field parameters.
Integrated understanding and memory through resonance.
Physical hardware compatibility for optical or electromagnetic computing.

### Alternative Embodiments

The TWAI framework may be extended to include:
Additional field components (e.g., cognitive, thermal, or chemical fields);
Variable or self-adjusting collapse thresholds;
Hierarchical wave coupling between multiple agents; and
Hybrid neural-TWMSE architectures where neural layers provide sensory preprocessing and TWMSE governs collapse logic.

1. A system for implementing artificial intelligence through deterministic wave interference and collapse logic, comprising:
(a) a processor or field computation unit configured to represent an artificial agent as a system wavefunction;
(b) one or more observer field modules configured to represent external or internal field wavefunctions;
(c) an interference module configured to compute a cumulative collapse function as a weighted sum of field amplitudes; and
(d) a decision module configured to trigger deterministic collapse into a defined state when said function exceeds a collapse threshold.
The system of claim 1, wherein observer wavefunctions correspond to physical fields selected from electromagnetic, gravitational, weak nuclear, or strong nuclear interactions.
The system of claim 1, wherein the collapse event produces an interpretable semantic state representing comprehension or meaning.
The system of claim 1, further comprising an adaptive feedback system configured to modify field coefficients based on prior collapse efficiency or success outcomes.
The system of claim 1, wherein residual interference patterns resulting from collapse are stored as resonant memory traces.
The system of claim 5, wherein stored resonance patterns are reactivated through re-stimulation of field geometry to retrieve prior states or experiences.
The system of claim 1, wherein the computation of interference and collapse is implemented using physical hardware selected from optical interference circuits, electromagnetic resonant substrates, or neuromorphic field processors.
A method for operating an artificial intelligence system based on deterministic field collapse, comprising:
(a) representing system and observer states as wavefunctions;
(b) computing cumulative interference between said wavefunctions;
(c) comparing the interference result to a collapse threshold; and
(d) executing a deterministic collapse into an action, comprehension, or memory state when the threshold is exceeded.
The method of claim 8, further comprising dynamically tuning field parameters through feedback to optimize collapse efficiency and learning performance.
The method of claim 8, further comprising storing post-collapse field resonances as retrievable memory configurations.
The method of claim 8, wherein computation occurs through physical field interference hardware operating in real time.
A non-transitory computer-readable medium storing instructions that, when executed, cause a computing system to perform the steps of claim 8.
The system or method of any preceding claim, wherein deterministic collapse replaces probabilistic inference, enabling physics-native artificial intelligence with integrated action, understanding, learning, memory, and hardware embodiment.
